(19) United States
(12) Patent Application Publication
(10) Pub. No.: US 2026/0270607 A1
(43) Pub. Date: Sep. 10, 2026

(54) Ear Seal

(71) Applicant: Hearing Components, Oakdale, MN (US)

(72) Inventors: Justin Peskar, St. Paul, MN (US); Ted Wiegandt, St. Paul, MN (US); Austin Fong, St. Paul, MN (US)

(21) Appl. No.: 19/558,620

(22) Filed: Mar. 6, 2026

Related U.S. Application Data
(60) Provisional application No. 63/767,791, filed on Mar. 6, 2025.
(60) Provisional application No. 63/781,435, filed on Apr. 1, 2025.

(51) Int. Cl. H04R 1/10

(52) U.S. Cl. CPC H04R 1/1083; H04R 1/1008; H04R 1/1058

(57) ABSTRACT

Embodiments herein describe a sound control device. The sound control device includes a circumaural ear cup. A cushion is coupled to the circumaural ear cup. The cushion includes an inner side wall, an outer side wall, and a central aperture extending therethrough. The outer side wall of the cushion includes a maximum outer wall height and a minimum outer wall height. The maximum outer wall height is greater than the minimum outer wall height.

### CROSS-REFERENCE TO RELATED APPLICATION

This application claims benefit of priority to U.S. Provisional Patent Application No. 63/767,791 filed on Mar. 6, 2025 and U.S. Provisional Patent Application No. 63/781,435, filed on Apr. 1, 2025, the entire disclosure of which is hereby incorporated by reference.

### TECHNICAL FIELD

The subject matter disclosed herein relates to headphones and sound control devices, and in particular, to foam pads and cushions for sealing the ear.

### BACKGROUND

A conventional cushioned headphone device includes a pair of cushions configured to press against a user's head and at least partially surround the outer ears of the user. In addition to isolating the user's ears from outside sounds, such cushions are intended to at least partially conform around irregularities of the head and outer ear of the user. However, known cushions lack the level of conformability to closely follow the contours of a user's anatomy while retaining sufficient durability to withstand continued use.

### SUMMARY

According to one aspect, a sound control includes a circumaural ear cup. A cushion is coupled to the circumaural ear cup. The cushion includes an inner side wall, an outer side wall, and a central aperture extending therethrough. The outer side wall of the cushion includes a maximum outer wall height and a minimum outer wall height. The maximum outer wall height is greater than the minimum outer wall height.

According to another aspect, a sound control device includes a circumaural ear cup. A strap is coupled to the circumaural ear cup. A spacer plate is coupled to the circumaural ear cup. The spacer plate includes a rim having a spacing thickness and an opening therethrough. A cushion is coupled to the spacer plate. The cushion includes an inner side wall, an outer side wall, and a central aperture extending therethrough. The outer side wall of the cushion includes a maximum outer wall height and a minimum outer wall height. The maximum outer wall height is greater than the minimum outer wall height

In another aspect, a sound control device includes a circumaural ear cup, a strap coupled to the circumaural ear cup, and a spacer plate coupled to the circumaural ear cup, the spacer plate including a rim having a spacing thickness and an opening therethrough, and a cushion coupled to the spacer plate, the cushion including an inner side wall, an outer side wall, and a central aperture extending therethrough, the outer side wall of the cushion including a maximum outer wall height and a minimum outer wall height, wherein the maximum outer wall height is greater than the minimum outer wall height. The cushion includes a posterior portion, an anterior portion, and an inferior portion, wherein the inferior portion of the cushion includes an intermediate peak of the outer side wall.

### BRIEF DESCRIPTION OF THE DRAWINGS

FIG. 1 is an isometric view of a sound control device, according to some embodiments.

FIG. 2A is an isometric view of the cushion of the sound control device, according to some embodiments.

FIG. 2B is a side view of the cushion of the sound control device, according to some embodiments.

FIG. 2C is a diagrammatic front view of the cushion of the sound control device, according to some embodiments.

FIG. 2D is an isometric bottom view of the cushion positioned on an exemplary user's head, according to some embodiments.

FIG. 3 is a side view of a cushion for a sound control device, according to some embodiments.

FIG. 4A is an isometric view of a cushion for a sound control device, according to some embodiments.

FIG. 4B is an isometric view of the cushion for a sound control device, according to some embodiments.

FIG. 5A is a graphical view of a pressure map of a sound control device, according to some embodiments.

FIG. 5B is a graphical view of a pressure map of a sound control device, according to some embodiments.

FIG. 5C is a graphical view of a pressure map of a sound control device, according to some embodiments.

FIG. 5D is a graphical view of a pressure map of a sound control device, according to some embodiments.

FIG. 6A is an isometric front view of a spacer plate for a sound control device, according to some embodiments.

FIG. 6B is an isometric rear view of the spacer plate for a sound control device, according to some embodiments.

FIG. 6C is an isometric rear view of the spacer plate with a foam insert for a sound control device, according to some embodiments.

FIG. 7 is graph of insertion loss (dB) versus frequency (Hz) for three sound control devices, according to some embodiments.

### DETAILED DESCRIPTION

The present disclosure describes devices, systems, and/or methods of sealing the user's ear from outside noise with a cushioned sound control device (e.g., headphones). The sound control device includes a cushion to press against a user's head and at least partially surround the outer ears of the user. The cushion includes a contoured wall extending from a base plate. The contoured wall is configured to reflect the shape of the user's head, i.e., to apply an even pressure at all locations around the perimeter of the contoured wall upon a user. For instance, regions of a user's head may have depressions (e.g., the region between the jaw and the neck) and projections (e.g., the cheekbone), and the contoured wall may be shaped accordingly to match the depressions and projections to form a seal around the ear. Applying even pressure around the perimeter of the cushion may be beneficial, as the cushion may thereby form a strong sound seal, as compared to uneven pressure distribution where sound may easily permeate through the low-pressure region(s). Applying even pressure around the perimeter of the cushion may improve user comfort by reducing high-pressure regions and may improve durability of the cushion by reducing high-compression regions of the cushion.

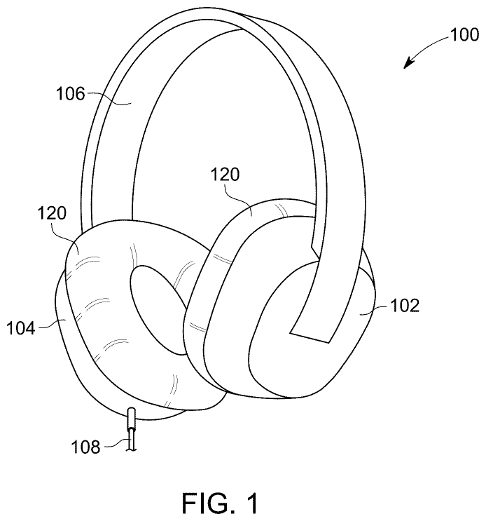

FIG. 1 is an isometric view of a sound control device 100, according to some embodiments. The sound control device 100 may include headphones, headsets, earmuffs, or other over-the-ear type (i.e., circumaural) devices configured to surround or encompass the ears of the user. The sound control device 100 may include foam pads or cushions 120 for secure yet comfortable placement over and/or on the ears of a user. The sound control device 100 may include a pair of earpieces including a pair of circumaural cups 102, 104 for placement over or on the ears of a user, and a headband or strap 106 extending between and connecting the circumaural cups 102, 104 of the sound control device 100. The strap 106 may provide a resilient force to urge the earpieces (e.g., the cushions 120 of the earpieces) into contact with the head and/or cars of the user to help retain the sound control device 100 on the user's head. The strap 106 may be curved to conform around a portion of the user's head and/or adjustable in length to accommodate different sized heads. The cushions 120 may be secured directly or indirectly to a perimeter of the circumaural cups 102, 104 by any desired means, including mechanical fasteners or devices, adhesive compositions, or other fastening mechanisms. In instances in which the sound control device 100 is a set of headphones, a cord 108 may extend from one or both of the earpieces to provide an electrical pathway for transmitting an audio signal to transducers or drivers fitted in the earpieces, or the transducers or drivers in the earpieces of the headphones may wirelessly receive an audio signal.

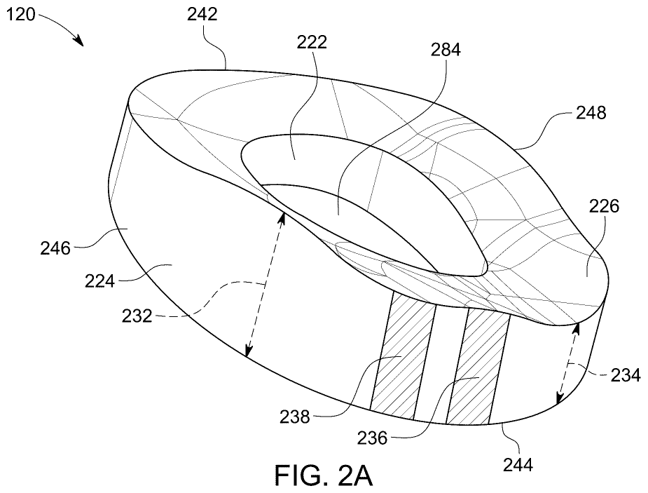

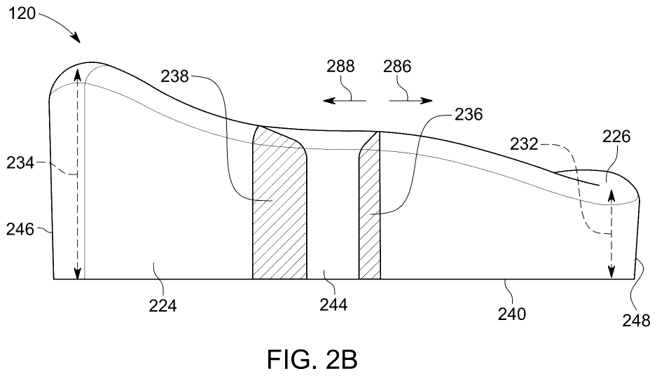

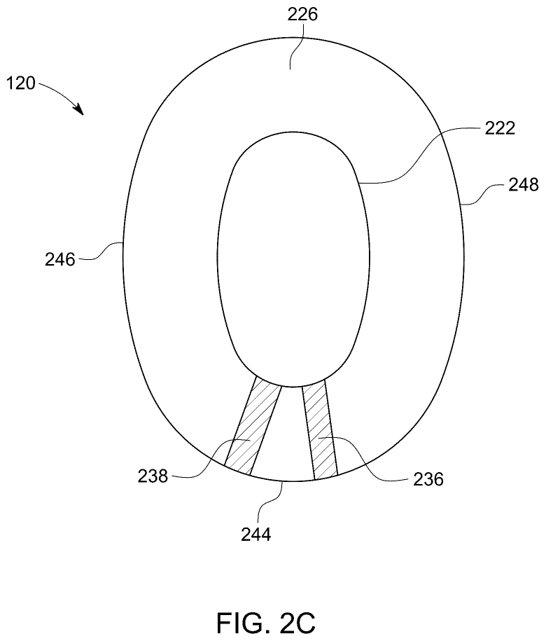

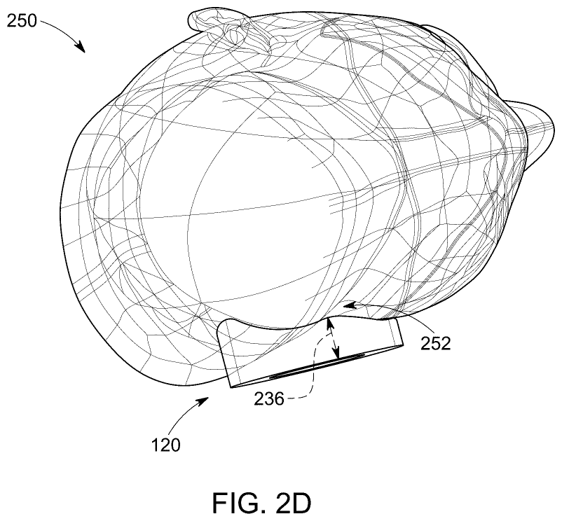

FIG. 2A is an isometric view of the cushion 120 of the sound control device 100, according to some embodiments. The cushion 120 includes an inner side wall 222, an outer side wall 224, and an engagement surface 226 configured to engage a user's head (i.e., the engagement surface 226 faces the user's head). The outer side wall 224 includes a first height 232 (e.g., a maximum height) at a first location and a second height 234 (e.g., a minimum height) at a second location. The first height 232 is greater than the second height 234. The height of the outer side wall 224 varies around the periphery of the cushion 120, and thus, the cushion 120 is contoured to follow the shape of the user's head. For instance, the first height 232 of the outer side wall 224 may be configured to be received on the user's neck and/or behind the car (i.e., a depression on the user's head). The height of the inner side wall 222 may be less than or equal to the height of the outer side wall 224 along the entire perimeter of the cushion 120, according to some embodiments. The cushion 120 includes a central aperture 284 to at least partially receive an ear of the user therein.

The cushion 120 includes an inferior portion 244, a superior portion 242, a posterior portion 246, and an anterior portion 248. The inferior portion 244 is positioned on/adjacent to the inferior portion (lower portion) of the ear, the superior portion 242 is positioned on/adjacent to the superior portion (upper portion) of the ear, the posterior portion 246 is positioned on/adjacent to the posterior portion (rear portion) of the ear, and the anterior portion 248 is positioned on/adjacent to the anterior portion (forward portion) of the ear. The inferior portion 244 includes an intermediate peak 236. Between the intermediate peak 236 and the posterior portion 246 includes an intermediate depression 238.

FIG. 2B is an inferior side view of the cushion 120 of the sound control device 100, according to some embodiments. The outer side wall 224 includes the first height 232, the second height 234, the intermediate peak 236, and an intermediate depression 238 extending between a cup-side surface 240 and the engagement surface 226. The intermediate peak 236 is greater than or equal to the intermediate depression 238. The intermediate peak 236 may be configured to be received between the user's jaw and neck (i.e., a depression on the user's head).

The outer side wall 224 descends in height from the intermediate peak 236 along a first direction 286 toward the anterior portion 248 and descends in height from the intermediate peak 236 along a second direction 288 toward the posterior portion 246. The intermediate depression 238 may be located between the intermediate peak 236 and the posterior portion 246. The intermediate depression 238 may have a height less than or equal to the intermediate peak 236. The outer side wall 224 may increase in height from the intermediate depression 238 along the second direction 288 toward the posterior portion 246. The intermediate peak 236 may be beneficial for providing a sealing surface around the entire ear, as for instance, there may be a contour (or channel) between a user's jaw and neck. The intermediate peak 236 may be configured to be received in, and seal, the contour (or channel) between a user's jaw and neck.

In some embodiments a ratio of the intermediate peak 236 to the intermediate depression 238 may be within a range between 1:1 and 2:1, in some embodiments, the range may be between 10:9 and 5:3, and in some embodiments, the range may be between 5:4 and 5:3. In some embodiments, a ratio between the first height 232 and the second height 234 may be within a range between 1:3 and 4:5, the range may be between 1:2 and 3:4, and in some embodiments the range may be between 1:2 and 2:3. In some embodiments, a ratio of the intermediate peak 236 to the second height 234 may be between 1:2 and 4:5, and in some embodiments the range may be between 2:3 and 4:5.

FIG. 2C is a diagrammatic front view of the cushion 120 of the sound control device 100, according to some embodiments. The locations of the intermediate peak 236 and the intermediate depression 238 are shown relative to the inferior portion 244, the posterior portion 246, and the anterior portion 248 of the cushion 120. In some embodiments, the distance between the outer side wall 224 and the inner side wall 222 may be less than 1 inch, and in some embodiments, may be within a range of 0.7 inches and 0.3 inches. In another embodiment, the distance between the outer side wall 224 and the inner side wall 222 may be greater than 1 inch, and in some embodiments, may be within a range of 1.1 inches and 1.3 inches. A distance between the intermediate depression 238 and the intermediate peak 236 may be less than 1 inch, and in some embodiments, may be within a range of 0.7 inches and 0.3 inches. In another embodiment, the distance between the intermediate depression 238 and the intermediate peak 236 may be greater than 1 inch, and in some embodiments, may be within a range of 1.1 inches and 1.3 inches. The distance between the intermediate peak 236 and the intermediate depression 238 is important for providing a seal, as the contour between the jaw and neck is generally 1 inch or less, and therefore, the intermediate peak 236 can be sized to fit (and/or exceed) the dimensions of the contour. Exceeding the dimensions of the contour may be beneficial, as the foam material of the cushion 120 may compress into the contour to provide a resilient seal.

FIG. 2D is an isometric inferior view of the cushion 120 positioned on an exemplary user's head 250, according to some embodiments. The intermediate peak 236 is aligned with a jaw contour 252 positioned between the user's jaw and neck. The intermediate peak 236 fills in the jaw contour 252 such that no gap (or low pressure coupling) is present between the cushion 120 and the user's head 250.

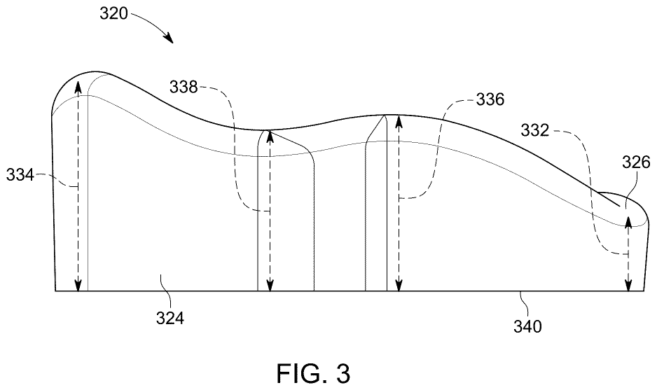

FIG. 3 is an inferior side view of a cushion 320 for a sound control device, according to some embodiments. The cushion 320 may be used with the sound control device 100. An outer side wall 324 includes a minimum height 332, a maximum height 334, an intermediate peak 336, and an intermediate depression 338 extending between a cup-side surface 340 and an engagement surface 326. The intermediate peak 336 is greater than or equal to the intermediate depression 338. The intermediate peak 336 may be configured to be received between the user's jaw and next (i.e., a depression on the user's head).

In some embodiments a ratio of the intermediate peak 336 to the intermediate depression 338 may be within a range between 10:9 and 2:1, in some embodiments, the range may be between 10:9 and 3:2, and in some embodiments, the range may be between 5:4 and 5:3. In some embodiments, a ratio between the minimum height 332 and the maximum height 334 may be within a range between 1:3 and 4:5, the range may be between 1:2 and 3:4, and in some embodiments the range may be between 1:2 and 2:3. In some embodiments, a ratio of the intermediate peak 336 to the maximum height 334 may be between 1:2 and 9:10, and in some embodiments the range may be between 2:3 and 4:5. The height outer side wall 324 may be recessed (or decreased) on both sides extending from the intermediate peak 336.

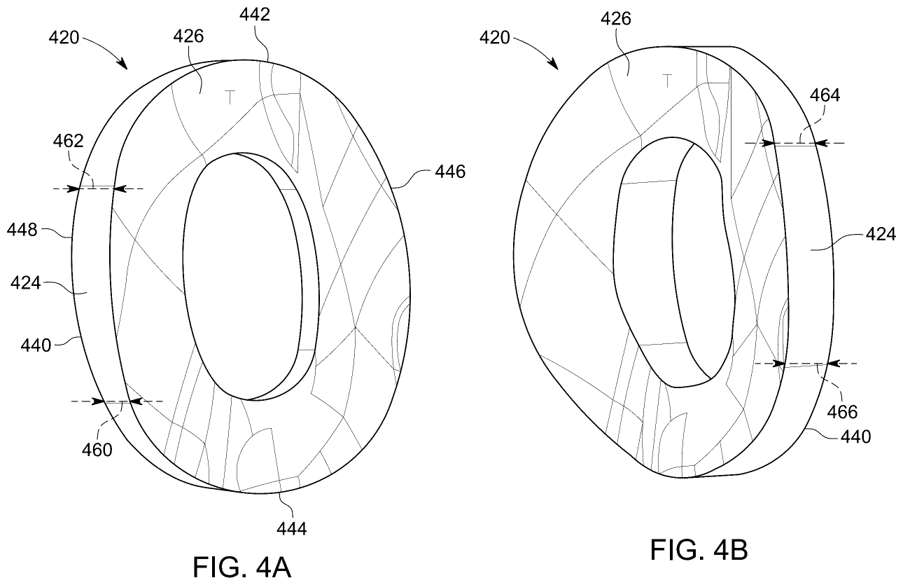

FIG. 4A is an isometric view of a cushion 420 for a sound control device, according to some embodiments. The cushion 420 may be used with the sound control device 100. An outer wall 424 of the cushion 420 includes a first height 460 and a second height 462 (or thickness) between a cup-side surface 440 and an engagement surface 426. The cushion 420 includes an inferior portion 444, a superior portion 442, a posterior portion 446, and an anterior portion 448. The inferior portion 444 is positioned on/adjacent to the inferior portion (lower portion) of the ear, the superior portion 442 is positioned on/adjacent to the superior portion (upper portion) of the ear, the posterior portion 446 is positioned on/adjacent to the posterior portion (rear portion) of the ear, and the anterior portion 448 is positioned on/adjacent to the anterior portion (forward portion) of the ear.

FIG. 4B is an isometric view of the cushion 420 for a sound control device, according to some embodiments. The outer wall 424 of the cushion 420 includes a third height 464 and a fourth height 466 (or thickness) between the cup-side surface 440 and the engagement surface 426. The following table (table 1) is a list of possible dimensions for each of the first height 460, second height 462, third height 464, and fourth height 466 for five different sized embodiments of the cushion 420, where all measurements are within a range of ±0.100 inches.

TABLE 1

| | First | Second | Third | Fourth |
|---|---|---|---|---|
| Model | height 460 | height 462 | height 464 | height 466 |
| Large | 0.815 | 0.514 | 0.505 | 0.573 |
| Medium | 0.796 | 0.450 | 0.410 | 0.573 |
| Short Wide | 0.874 | 0.508 | 0.469 | 0.671 |
| Long Narrow | 0.882 | 0.566 | 0.500 | 0.587 |
| Small | 0.722 | 0.355 | 0.393 | 0.626 |

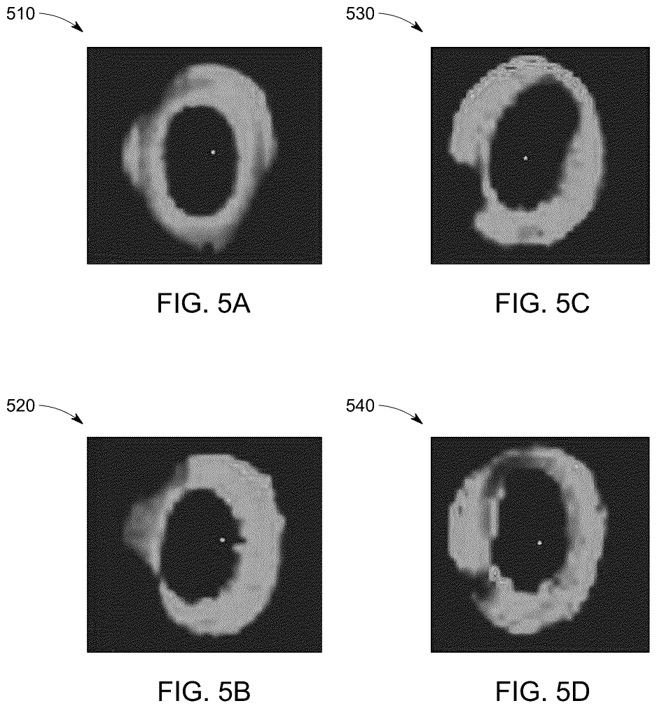

FIG. 5A is a graphical view of a pressure map 510 of a sound control device, according to some embodiments. The sound control device includes the cushion 120 having contoured walls to evenly distribute pressure around the patient's head.

FIG. 5B is a graphical view of a pressure map 520 of a sound control device, according to some embodiments. The sound control device includes the cushion 120 having contoured walls to evenly distribute pressure around the patient's head.

FIG. 5C is a graphical view of a pressure map 530 of a sound control device, according to some embodiments. The sound control device includes the cushion 320 having contoured walls to evenly distribute pressure around the patient's head.

FIG. 5D is a graphical view of a pressure map 540 of a sound control device, according to some embodiments. The sound control device includes the cushion 120 having contoured walls to evenly distribute pressure around the patient's head.

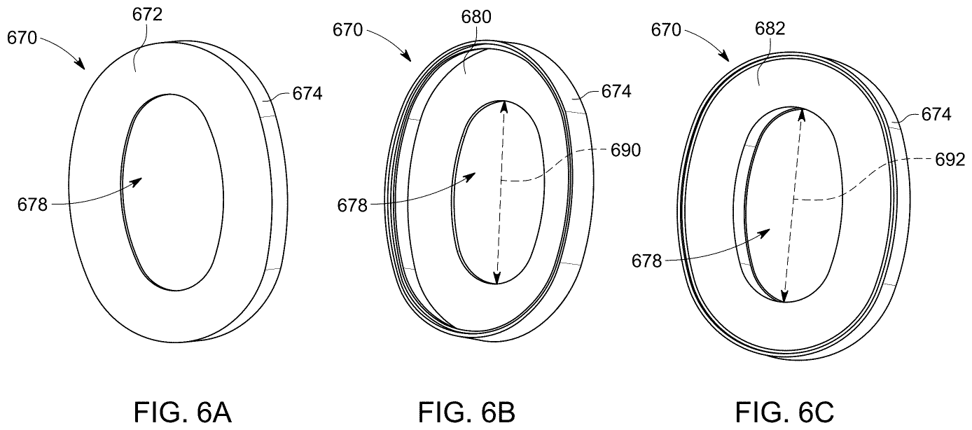

FIG. 6A is an isometric front view of a spacer plate 670 for a sound control device, according to some embodiments. The spacer plate 670 may be positioned between the cup 102/104 and the cushion 120 to increase the cup volume, and provide an enhanced sound barrier. The spacer plate 670 may include a first surface 672, a rim 674 extending from the first surface 672, and an opening 678 extending through the middle of the spacer plate 670.

FIG. 6B is an isometric rear view of the spacer plate 670 for a sound control device, according to some embodiments. The spacer plate 670 includes a second surface 680 opposite to the first surface 672. The second surface 680 may be recessed from the rim 674 such that a cavity or depression is formed. The opening 678 may include a first height 690.

FIG. 6C is an isometric rear view of the spacer plate 670 with a foam insert 682 for a sound control device, according to some embodiments. The foam insert 682 may be received within the cavity or depression formed by the recessed second surface 680 and the rim 674. The opening 678 may include a second height 692. The first height 690 may be greater than the second height 692, as the foam insert 682 may extend radially inward into the opening 678.

The rim 674 of the spacer plate 670 may be configured to secure to the cup 102/104 of the sound control device 100. For instance, the second surface 680 and/or the foam insert 682 may face the cup 102/104 and the first surface 672 may face the user's ear. The cushion 120 (and/or the cushion 320, 420) may be secured to the first surface 672. For example, the cup-side surface 240 (and/or the cup-side surface 340, 440) may be secured to the first surface 672 via an adhesive and/or mechanical connection.

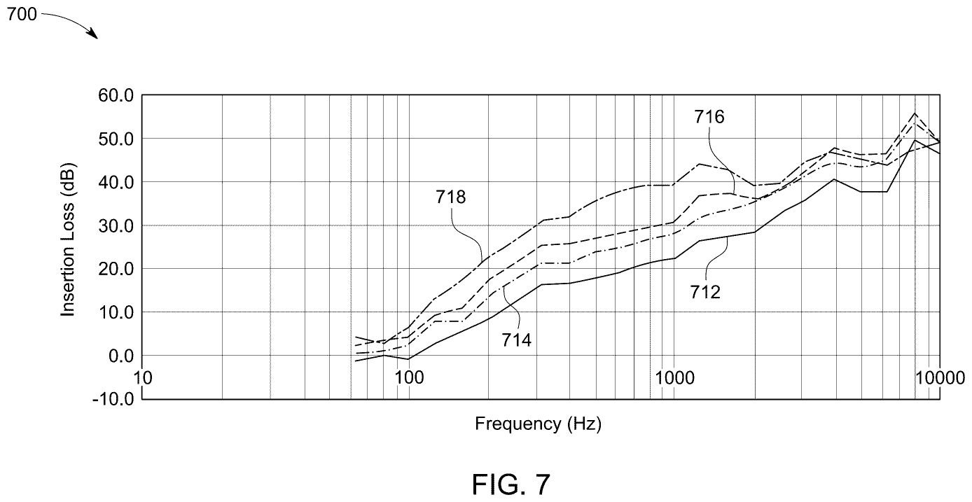

The spacer plate 670 may be configured to increase an internal volume of the sound control device 100. For instance, the thickness of the spacer plate 670 (e.g., the rim 674 and/or the foam insert 682) spaces the cup-side surface 240, 340, 440 from the circumaural cup 102/104, and therefore, the engagement surface 226, 326, 426 of the cushion is positioned farther from the circumaural cup 102/104. The volume between the circumaural cup 102/104 and the engagement surface 226, 326, 426 is thereby increased by the spacer plate 670. Increasing the sound-sealed volume of the sound control device 100 is beneficial, as it may reduce insertion loss, thereby providing higher quality sound delivery and/or noise cancellation of external sound. The addition of the foam insert with the spacer plate 670 may decrease reflections and increase insertion loss. For instance, FIG. 7 provides exemplary data of insertion loss (dB) versus frequency (Hz) for sound control devices with different sized spacer plates.

FIG. 7 is graph 700 of insertion loss (dB) versus frequency (Hz) for four exemplary sound control devices, according to some embodiments. The first sound control device, represented by plot 712, includes a cushion (e.g., the cushion 120, 320, 420) without the spacer plate 670 and without the foam insert 682. The second sound control device, represented by plot 714, includes the cushion 120, 320, 420 with a 10 mm spacer plate 670, but without the foam insert 682. The third sound control device, represented by plot 716, includes the cushion 120, 320, 420 with the spacer plate 670 (10 mm) and with a 10 mm foam insert (e.g. the foam insert 682). The fourth sound control device, represented by plot 718, includes the cushion 120, 320, 420 with the spacer plate 670 (20 mm) and with a 20 mm foam insert 682. Thus, the addition of a spacer plate improves insertion loss and the addition of a foam insert improves insertion loss.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

In some aspects, the techniques described herein relate to a sound control device, including: a circumaural ear cup; and a cushion coupled to the circumaural ear cup, the cushion including an inner side wall, an outer side wall, and a central aperture extending therethrough, wherein the outer side wall of the cushion includes a maximum outer wall height and a minimum outer wall height, wherein the maximum outer wall height is greater than the minimum outer wall height.

In some aspects, the techniques described herein relate to a sound control device, wherein the cushion includes a posterior portion, and anterior portion, and an inferior portion, wherein the inferior portion of the cushion includes an intermediate peak of the outer side wall.

In some aspects, the techniques described herein relate to a sound control device, wherein the outer side wall descends in height from the intermediate peak along a first direction toward the anterior portion and wherein the outer side wall descends in height from the intermediate peak along a second direction toward the posterior portion.

In some aspects, the techniques described herein relate to a sound control device, wherein the inferior portion of the cushion includes an intermediate depression between the intermediate peak and the posterior portion, wherein the intermediate peak includes an intermediate peak height and the intermediate depression includes an intermediate depression height, wherein the intermediate peak height is greater than the intermediate depression height.

In some aspects, the techniques described herein relate to a sound control device, wherein a ratio of the intermediate peak height to the intermediate depression height is within a range between 10:9 and 2:1.

In some aspects, the techniques described herein relate to a sound control device, wherein the maximum outer wall height is located between the intermediate peak and the posterior portion of the cushion.

In some aspects, the techniques described herein relate to a sound control device, wherein minimum outer wall height is located between the intermediate peak and the anterior portion of the cushion.

In some aspects, the techniques described herein relate to a sound control device, wherein a ratio of the minimum outer wall height to the maximum outer wall height is within a range of between 1:3 and 4:5.

In some aspects, the techniques described herein relate to a sound control device, wherein the inner side wall includes a maximum inner wall height, wherein the minimum outer wall height is greater than the maximum inner wall height.

In some aspects, the techniques described herein relate to a sound control device, further including: a spacer plate coupled to the circumaural ear cup, wherein the spacer plate is positioned between the circumaural ear cup and the cushion.

In some aspects, the techniques described herein relate to a sound control device, including: a circumaural ear cup; a strap coupled to the circumaural ear cup; a spacer plate coupled to the circumaural ear cup, the spacer plate including a rim having a spacing thickness and an opening therethrough; and a cushion coupled to the spacer plate, the cushion including an inner side wall, an outer side wall, and a central aperture extending therethrough, wherein the outer side wall of the cushion includes a maximum outer wall height and a minimum outer wall height, wherein the maximum outer wall height is greater than the minimum outer wall height.

In some aspects, the techniques described herein relate to a sound control device, further including an internal volume between the circumaural ear cup and the maximum outer wall height, wherein the spacing thickness of the spacer plate increases the internal volume.

In some aspects, the techniques described herein relate to a sound control device, wherein the spacer plate includes a first surface oriented to face the circumaural ear cup and a second surface oriented to face the cushion, wherein the second surface is recessed from the rim to receive a foam insert therein.

In some aspects, the techniques described herein relate to a sound control device, wherein the foam insert extends at least partially into the opening of the spacer plate.

In some aspects, the techniques described herein relate to a sound control device, wherein the cushion includes a posterior portion, and anterior portion, and an inferior portion, wherein the inferior portion of the cushion includes an intermediate peak of the outer side wall.

In some aspects, the techniques described herein relate to a sound control device, wherein the outer side wall descends in height from the intermediate peak along a first direction toward the anterior portion and wherein the outer side wall descends in height from the intermediate peak along a second direction toward the posterior portion.

In some aspects, the techniques described herein relate to a sound control device, wherein the inferior portion of the cushion includes an intermediate depression between the intermediate peak and the posterior portion, wherein the intermediate peak includes an intermediate peak height and the intermediate depression includes an intermediate depression height, wherein the intermediate peak height is greater than the intermediate depression height.

In some aspects, the techniques described herein relate to a sound control device, wherein a ratio of the intermediate peak height to the intermediate depression height is within a range between 10:9 and 2:1.

In some aspects, the techniques described herein relate to a sound control device, wherein the maximum outer wall height of is located between the intermediate peak and the posterior portion of the cushion and wherein the minimum outer wall height is located between the intermediate peak and the anterior portion of the cushion.

In some aspects, the techniques described herein relate to a sound control device, wherein a ratio of the minimum outer wall height to the maximum outer wall height is within a range of between 1:3 and 4:5.

In some aspects, a sound control device includes a circumaural ear cup, a strap coupled to the circumaural ear cup, and a spacer plate coupled to the circumaural ear cup, the spacer plate including a rim having a spacing thickness and an opening therethrough, and a cushion coupled to the spacer plate, the cushion including an inner side wall, an outer side wall, and a central aperture extending therethrough, the outer side wall of the cushion including a maximum outer wall height and a minimum outer wall height, wherein the maximum outer wall height is greater than the minimum outer wall height. The cushion includes a posterior portion, an anterior portion, and an inferior portion, wherein the inferior portion of the cushion includes an intermediate peak of the outer side wall.

1. A sound control device, comprising:
a circumaural ear cup; and
a cushion coupled to the circumaural ear cup, the cushion including an inner side wall, an outer side wall, and a central aperture extending therethrough, the outer side wall of the cushion including a maximum outer wall height and a minimum outer wall height, wherein the maximum outer wall height is greater than the minimum outer wall height,
wherein the cushion includes a posterior portion, an anterior portion, and an inferior portion, wherein the inferior portion of the cushion includes an intermediate peak of the outer side wall.

2. The sound control device of claim 1, wherein the outer side wall descends in height from the intermediate peak along a first direction toward the anterior portion and wherein the outer side wall descends in height from the intermediate peak along a second direction toward the posterior portion.

3. The sound control device of claim 1, wherein the inferior portion of the cushion includes an intermediate depression between the intermediate peak and the posterior portion, wherein the intermediate peak includes an intermediate peak height and the intermediate depression includes an intermediate depression height, wherein the intermediate peak height is greater than the intermediate depression height.

4. The sound control device of claim 3, wherein a ratio of the intermediate peak height to the intermediate depression height is within a range between 10:9 and 2:1.

5. The sound control device of claim 1, wherein the maximum outer wall height is located between the intermediate peak and the posterior portion of the cushion.

6. The sound control device of claim 5, wherein minimum outer wall height is located between the intermediate peak and the anterior portion of the cushion.

7. The sound control device of claim 6, wherein a ratio of the minimum outer wall height to the maximum outer wall height is within a range of between 1:3 and 4:5.

8. The sound control device of claim 1, wherein the inner side wall includes a maximum inner wall height, wherein the minimum outer wall height is greater than the maximum inner wall height.

9. The sound control device of claim 1, further comprising:
a spacer plate coupled to the circumaural ear cup, wherein the spacer plate is positioned between the circumaural ear cup and the cushion.

10. A sound control device, comprising:
a circumaural ear cup;
a strap coupled to the circumaural ear cup;
a spacer plate coupled to the circumaural ear cup, the spacer plate including a rim having a spacing thickness and an opening therethrough; and
a cushion coupled to the spacer plate, the cushion including an inner side wall, an outer side wall, and a central aperture extending therethrough.

11. The sound control device of claim 10, wherein the outer side wall of the cushion includes a maximum outer wall height and a minimum outer wall height, wherein the maximum outer wall height is greater than the minimum outer wall height.

12. The sound control device of claim 11, further comprising an internal volume between the circumaural ear cup and the maximum outer wall height, wherein the spacing thickness of the spacer plate increases the internal volume.

13. The sound control device of claim 11, wherein the spacer plate includes a first surface oriented to face the circumaural ear cup and a second surface oriented to face the cushion, wherein the second surface is recessed from the rim to receive a foam insert therein.

14. The sound control device of claim 13, wherein the foam insert extends at least partially into the opening of the spacer plate.

15. The sound control device of claim 11, wherein the cushion includes a posterior portion, and anterior portion, and an inferior portion, wherein the inferior portion of the cushion includes an intermediate peak of the outer side wall.

16. The sound control device of claim 15, wherein the outer side wall descends in height from the intermediate peak along a first direction toward the anterior portion and wherein the outer side wall descends in height from the intermediate peak along a second direction toward the posterior portion.

17. The sound control device of claim 15, wherein the inferior portion of the cushion includes an intermediate depression between the intermediate peak and the posterior portion, wherein the intermediate peak includes an intermediate peak height and the intermediate depression includes an intermediate depression height, wherein the intermediate peak height is greater than the intermediate depression height.

18. The sound control device of claim 17, wherein a ratio of the intermediate peak height to the intermediate depression height is within a range between 10:9 and 2:1.

19. The sound control device of claim 11, wherein a ratio of the minimum outer wall height to the maximum outer wall height is within a range of between 1:3 and 4:5.

20. A sound control device, comprising:
a circumaural ear cup;
a strap coupled to the circumaural ear cup; and
a spacer plate coupled to the circumaural ear cup, the spacer plate including a rim having a spacing thickness and an opening therethrough; and
a cushion coupled to the spacer plate, the cushion including an inner side wall, an outer side wall, and a central aperture extending therethrough, the outer side wall of the cushion including a maximum outer wall height and a minimum outer wall height, wherein the maximum outer wall height is greater than the minimum outer wall height,
wherein the cushion includes a posterior portion, an anterior portion, and an inferior portion, wherein the inferior portion of the cushion includes an intermediate peak of the outer side wall.
